(19) United States
(12) Patent Application Publication
(10) Pub. No.: US 2018/0180532 A1
(43) Pub. Date: Jun. 28, 2018

(54) MULTIPLE WAVELENGTH OPTICAL SYSTEM

(71) Applicants: Sheng-Hao TSENG, Tainan City (TW); Kang-Yu CHU, (US); METAL INDUSTRIES RESEARCH & DEVELOPMENT CENTRE, KAOHSIUNG (TW)

(72) Inventors: Ming-Hui CHEN, Kaohsiung City (TW); Kang-Yu CHU, Chiayi City (TW); Sheng-Hao TSENG, Tainan City (TW)

(21) Appl. No.: 15/390,697

(22) Filed: Dec. 26, 2016

(51) Int. Cl. G01N 21/25; G02B 5/02; G02B 3/00; G02B 19/00; G01N 21/27

(52) U.S. Cl. CPC G01N 21/255; G02B 5/0278; G02B 3/00; G02B 19/0014; G01N 2201/06146; G01N 21/27; G02B 2003/0093; G01N 2201/06113; G02B 19/0047

(57) ABSTRACT

A multiple wavelength optical system includes plural solid state light sources, an optical diffuser, a lens assembly, and at least one photodetector. The solid state light sources have different wavelength ranges respectively. The optical diffuser has an incident surface and an exit surface opposite to the incident surface. The solid state light sources are disposed opposite the incident surface, and the lens assembly is disposed opposite the exit surface. Each of the solid state light sources faces the incident surface in the same direction. The lights of the solid state light sources enter the optical diffuser and exit from the exit surface, and then are focused by the lens assembly. Finally, the focused lights are projected on a surface of an object. At least one photodetector receives the reflected lights and the penetrating lights from the surface of the object.

### BACKGROUND OF THE INVENTION

### Field of Invention

The present invention relates to an optical system. More particularly, the present invention relates to a multiple wavelength optical system for an optical probe.

### Description of Related Art

Multiple wavelength light sources are important devices to measure the spectral data of a biomedical tissue. Traditionally, broadband light sources, e.g. halogen lamps or gas discharge lamps, are used to measure the spectral data of the biomedical tissue. However, these broadband light sources have some problems, such as the lower efficiency of photoelectric conversion and heat emission.

In order to overcome the above problems of the broadband light sources, solid state light sources, e.g. the light emitting diodes or the laser diodes, are mostly chosen to replace the broadband light sources. The solid state light sources have better efficiency of photoelectric conversion, but the bandwidth range of the solid state light sources is far less than that of the traditional broadband light sources. Therefore, before the solid state light sources are used to measure the spectral data of the biomedical tissue, the lights of the solid state light sources having different wavelength ranges need to be mixed with each other. For conventional multiple wavelength optical systems using the solid state light sources, complex optical devices, e.g. the precise lens structure or the optical fiber array, are usually required for achieving the mixing and focusing of the lights. For example, U.S. Pat. No. 5,655,832 uses complex lens design to complete mixing and focusing of lights. For another example, Taiwan Patent Number M526696 uses optical fiber array module to complete mixing and focusing of lights. Therefore, the conventional multiple wavelength optical systems using the solid state light sources have several disadvantages, such as stringent alignment tolerance, complex design, difficulty to miniaturize, and high cost. In view of this, there is a need to improve the conventional multiple wavelength optical systems.

### SUMMARY OF THE INVENTION

An object of the present invention is to provide a multiple wavelength optical system. The multiple wavelength optical system is configured to mix and focus the lights of plural solid state light sources having different wavelength ranges. The multiple wavelength optical system not only retains the advantage of the solid state light sources having better efficiency of photoelectric conversion, but also has several advantages, such as multiple wavelengths, simple structure, uniform light distribution and low cost.

According to the object of the present invention, a multiple wavelength optical system is provided. The multiple wavelength optical system includes plural solid state light sources, an optical diffuser, a lens assembly, and at least one photodetector. The solid state light sources have different wavelength ranges respectively. The optical diffuser has an incident surface and an exit surface opposite to the incident surface. The solid state light sources are disposed opposite the incident surface, and the lens assembly is disposed opposite the exit surface. Each of the solid state light sources faces the incident surface in the same direction. The lights of the solid state light sources enter the optical diffuser and exit from the exit surface. Next, the lights of the solid state light sources are focused by the lens assembly. Finally, the focused lights are projected on a surface of an object. At least one photodetector receives the reflected lights or the penetrating lights from the surface of the object to receive the lights.

According to some embodiments of the present invention, the multiple wavelength optical system further includes a control module. The control module is electrically connected to the solid state light sources to control luminous intensity of the solid state light sources.

According to some embodiments of the present invention, the control module is configured to modulate luminous frequency of the solid state light sources.

According to some embodiments of the present invention, the solid state light sources are the laser diodes or the light emitting diodes.

According to some embodiments of the present invention, the lens assembly is an achromatic lens set or a ball lens.

According to some embodiments of the present invention, the multiple wavelength optical system further includes a signal processing module. The signal processing module is electrically connected to the at least one photodetector, thereby enabling the signal processing module to perform signal processing to obtain plural spectral data.

### BRIEF DESCRIPTION OF THE DRAWINGS

The invention can be more fully understood by reading the following detailed description of the embodiment, with reference made to the accompanying drawings as follows:

FIG. 1 is a block diagram of a multiple wavelength optical system according to an embodiment of the present invention.

### DETAILED DESCRIPTION

Specific embodiments of the present invention are further described in detail below with reference to the accompanying drawings, however, the embodiments described are not intended to limit the present invention and it is not intended for the description of operation to limit the order of implementation. Moreover, any device with equivalent functions that is produced from a structure formed by a recombination of elements shall fall within the scope of the present invention. Additionally, the drawings are only illustrative and are not drawn to actual size.

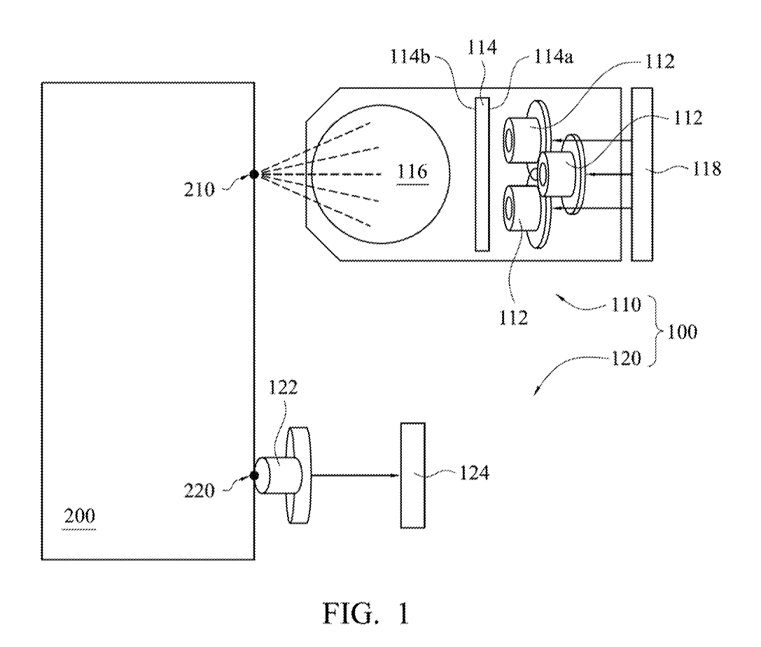

FIG. 1 is a block diagram of a multiple wavelength optical system 100 according to an embodiment of the present invention. The multiple wavelength optical system 100 includes a light source module 110 and a light receiving module 120. The light source module 110 includes plural solid state light sources 112, an optical diffuser 114, a lens assembly 116, and a control module 118. The light receiving module 120 includes a photodetector 122 and a signal processing module 124. The solid state light sources 112 have different wavelength ranges respectively. The optical diffuser 114 has an incident surface 114a and an exit surface 14b opposite to the incident surface 114a. Each of the solid state light sources 112 faces the incident surface 114a of the optical diffuser 114 in the same direction. The lens assembly 116 is disposed opposite the exit surface 114b of the optical diffuser 114.

In the present embodiment the solid state light sources 112 are laser diodes or light emitting diodes. In the present embodiment, the lens assembly 116 is an achromatic lens set or a ball lens. The lens assembly 116 is configured to focus the lights having different wavelength ranges on the same plane. In the present embodiment, the number of the solid state light sources 112 is three, but the embodiments of the present invention are not limited thereto.

The lights of the solid state light sources 112 enter the incident surface 114a of the optical diffuser 114. Then, the lights of the solid state light sources 112 are mixed with each other within the optical diffuser 114. Thereafter, the mixed lights exit from the exit surface 114b of the optical diffuser 114. Then, the mixed lights are focus by the lens assembly 116. Finally, the focused lights are projected on a first position 210 of a surface of an object 200 to be measured. In the present embodiment, the object 200 is a biological tissue.

During the process of mixing the lights, the directivities of the lights having different wavelength ranges are eliminated after several times of the diffusion of the lights, and thus the lights are evenly mixed. Therefore, the mixed lights passing through the optical diffuser 114 have the same spatial distribution.

It is worth mentioning that a user can adjust a relative distance between the light sources 110 and the object 200 in accordance with the actual demands of the user, thereby enabling the lights to be focused on a specific position of the surface or an interior of the object 200.

The control module 118 is electrically connected to the solid state light sources 112. The control module 118 is configured to control luminous intensity of the solid state light sources 112 and modulate luminous frequency of the solid state light sources 112 in accordance with the actual demands of the user. In the present embodiment, the control module 118 is configured to enable the lights emitted from the solid state light sources 112 to have different luminous frequencies. Therefore, the lights emitted from the solid state light sources 112 are distinguishable after the lights are received.

The photodetector 112 faces and is disposed on a second position 220 of the surface of the object 200. In the present embodiment, the number of the photodetector 112 is one, but the embodiments of the present invention are not limited thereto. The user can adjust the number of the photodetector in accordance with the actual demands of the user.

In the present embodiment, the mixed and focused lights are projected on the first position 210 of the surface of the object 200, and the photodetector 122 is disposed on the second position 220 of the surface of the object 200 to receive reflected lights. However, the embodiments of the present invention are not limited thereto. The photodetector 122 can be disposed on a relative position of another surface of the object 200 to receive penetrating lights.

The signal processing module 124 is electrically connected to the photodetector 122. The signal processing module 124 is configured to receive a signal outputting from the photodetector 112 and perform signal processing to obtain plural spectral data. It is worth mentioning that the user can connect the signal processing module 124 to a device having built-in specific algorithms to measure concentration of a specific substance of the object 200.

In the following description, an application example is provided to illustrate how to use the multiple wavelength optical system of the present disclosure to quantitatively measure the concentration of the specific substance of the biological tissue. That is, the above object 200 to be measured is the biological tissue. In this application example, at first, lights emitted from plural solid state light sources are mixed and focused on the surface of the biological tissue. Thereafter, the lights are affected by the specific substance and structure of the biological tissue during photons of the lights passing through the biological tissue, and then absorbing and scattering of the photons occur. Then, energy attenuation and phase change of the lights occur. Finally, quantitative analysis for the concentration of the specific substance in the biological tissue is performed by analyzing the above spectral change through applying algorithms of a diffuse reflection spectroscopy. It is worth mentioning that a processing flow of the above algorithms is shown below: a light having a specific wavelength range is analyzed to obtain a magnitude change and a phase change of the light when the light enters the biological tissue, and then the absorbing and scattering of the light having the specific wavelength range are analyzed when the light is affected by the specific substance, thereby calculating the concentration of the specific substance. For example, if three solid state light sources respectively having peak wavelengths of 660 nm, 780 nm, and 830 nm are chosen to be used in the above multiple wavelength optical system, the multiple wavelength optical system can be used to measure a blood oxygenation saturation and a total hemoglobin concentration of the biological tissue.

In summary, the multiple wavelength optical system of the present invention not only retains the advantage of the solid state light source having better efficiency of photoelectric conversion, but also has several advantages, such as multiple wavelengths and uniform light distribution. In comparison with the conventional multiple wavelength optical systems using solid state light sources, the multiple wavelength optical system of the present invention has a lower requirement of alignment tolerance, a lower cost and a simpler design. Therefore, the multiple wavelength optical system of the present invention has a potential to be miniaturized and developed to a portable system.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A multiple wavelength optical system, comprising:
a plurality of solid state light sources having different wavelength ranges respectively;
an optical diffuser having an incident surface and an exit surface opposite to the incident surface, wherein the solid state light sources are disposed opposite the incident surface;
a lens assembly is disposed opposite the exit surface; and
at least one photodetector;
wherein each of the solid state light sources faces the incident surface in the same direction, and the lights of the solid state light sources enter the optical diffuser and exit from the exit surface, and the lights of the solid state light sources are focused by the lens assembly and then projected on a surface of an object;
wherein the at least one photodetector receives a portion of the lights reflected by the object or a portion of the lights penetrating the object from the surface of the object.

2. The multiple wavelength optical system of claim 1, further comprising a control module electrically connected to the solid state light source to control luminous intensity of the solid state light sources.

3. The multiple wavelength optical system of claim 2, wherein the control module is configured to modulate luminous frequency of the solid state light sources.

4. The multiple wavelength optical system of claim 1, wherein the solid state light sources are the laser diodes or the light emitting diodes.

5. The multiple wavelength optical system of claim 1, wherein the lens assembly is an achromatic lens set or a ball lens.

6. The multiple wavelength optical system of claim 1, further comprising a signal processing module electrically connected to the at least one photodetector, and the signal processing module is configured to perform signal processing to obtain a plurality of spectral data.
